(19) United States
(12) Patent Application Publication
(10) Pub. No.: US 2012/0313921 A1
(43) Pub. Date: Dec. 13, 2012

(54) STEREOSCOPIC IMAGE GENERATING DEVICE

(75) Inventor: Toshiro OHBITSU, Akishimashi (JP)

(73) Assignee: FUJITSU LIMITED, Kawasaki-shi (JP)

(21) Appl. No.: 13/458,621

(22) Filed: Apr. 27, 2012

(30) Foreign Application Priority Data
Jun. 10, 2011 (JP) 2011-130056

(51) Int. Cl. G09G 5/00; G09G 3/00

(52) U.S. Cl. 345/212; 345/32

(57) ABSTRACT

A stereoscopic image generating device comprising: a display device to include a plurality of pixels which emit brightness and non-brightness-emitting portions in the peripheries of the pixels; a lattice unit to be installed in parallel with a display surface as well as being adjacent to the display surface of the display device and to include a brightness-emitting portion which covers the non-brightness-emitting portions; and an optical unit to be installed in parallel with the lattice unit as well as being adjacent to the lattice unit and to include lens portions which form images of the light coming from the pixels at predetermined image-forming points.

### CROSS-REFERENCE TO RELATED APPLICATION

This application is based upon and claims the benefit of priority of the prior Japanese Patent Application No. 2011-130056 filed on Jun. 10, 2011, the entire contents of which are incorporated herein by reference.

### FIELD

The present invention relates to a stereoscopic image generating device.

### BACKGROUND

There is a stereoscopic image generating device which generates images enabling a three dimensional vision (3D) by making use of parallax between the images captured by two cameras adjacent to each other. The stereoscopic image generating device generates and displays, in the images captured by, e.g., the two cameras adjacent to each other, the image captured by one camera as the image for the left eye and the image captured by the other camera as the image for the right eye.

The parallax is a difference between a position of the image for the left eye and a position of the image for the right eye with respect to the same object. In two objects existing within the image, one object appears to exist nearer or farther in a depthwise direction with respect to the other object due to the difference in parallax quantity. A parallax quantity is a magnitude of the parallax.

FIG. 1 is a diagram illustrating an example of a stereoscopic image. In FIG. 1, an image 910 is the image for the left eye, while an image 920 is the image for the right eye. Herein, an object A, an object B and an object C exist in each of the image 910 as the image for the left eye and the image 920 as the image for the right eye. Due to the parallaxes among these objects between the image 910 and the image 920, the object A, the object B and the object C appear to exist in this sequence from the nearest to a person who watches the stereoscopic image in FIG. 1.

The stereoscopic image generating device displays the image for the left eye to the left eye of a user and the image for the right eye to the right eye, thereby making the user feel a three-dimensional (stereoscopic) image. The stereoscopic image generating device displays the image for the left eye to the left eye and the image for the right eye to the right eye by use of, e.g., a liquid crystal display and dedicated eyeglasses worn by the user, thereby making the user perceive a stereoscopic vision.

### DOCUMENTS OF PRIOR ARTS

### Patent Document

[Patent document 1] Japanese Patent Application Laid-Open Publication No. 2005-176004
[Patent document 2] Japanese Patent Application Laid-Open Publication No. 2008-66086
[Patent document 3] Japanese Patent Application Laid-Open Publication No. 2007-041425
[Patent document 4] Japanese Patent Application Laid-Open Publication No. H06-301033
[Patent document 5] Japanese Patent Application Laid-Open Publication No. 2000-98119
[Patent document 6] Japanese Patent Application Laid-Open Publication No. H04-035192

### Non-Patent Document

[Non-Patent document 1] A Glossary of Display Device, compiled by Japan Electronics and Information Technology Industries Association

### SUMMARY

Further, some of the stereoscopic image generating devices are configured to get different pictures visible to the left and right eyes respectively without using the dedicated eyeglasses by installing a lenticular lens sheet on a display device of the liquid crystal display etc. At this time, moire fringes might occur due to pixels (display elements) arrayed on a screen of the display device and lenses of a lens sheet that are arranged in parallel. The moire fringes are easy to occur especially when the lenses of the lens sheet are arranged in directions that are non-parallel with array directions of the display elements on the screen. The moire fringes are fringe patterns (interference fringes) which occur due to periodic interference between image components. The moire fringes are one of causes to deteriorate a quality of the image to be displayed.

The screen of the display device contains a plurality of pixels (PIXEL). Each of the pixels on the display device contains a plurality of color elements (color pixels). The color elements are exemplified such as red (R), green (G) and blue (B). Black matrices exist at borders between the respective pixels. The black matrices are non-brightness-emitting portions. The black matrices at the borders between the respective pixels have an effect in making the display images clear when displaying normal 2D images. When the lens sheet is installed on the screen in order to visually recognize the stereoscopic image, however, the moire fringes might occur due to the black matrices at the borders between the pixels, a light intensity of the brightness-emitting portion and the lens sheet.

According to a first aspect, a stereoscopic image generating device includes: a display device to include a plurality of pixels which emit brightness and non-brightness-emitting portions in the peripheries of the pixels; a lattice unit to be installed in parallel with a display surface as well as being adjacent to the display surface of the display device and to include a brightness-emitting portion which covers the non-brightness-emitting portions; and an optical unit to be installed in parallel with the lattice unit as well as being adjacent to the lattice unit and to include lens portions which form images of the light coming from the pixels at predetermined image-forming points.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a stereoscopic image.

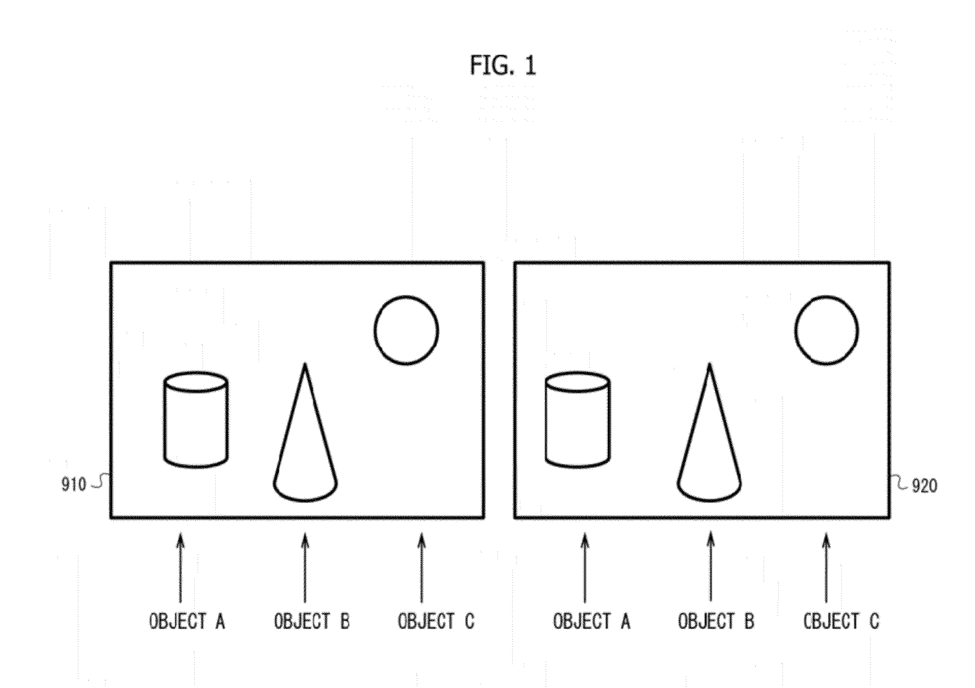

FIG. 2 is a view depicting an example of a configuration of a stereoscopic image generating device.

FIG. 3 is a diagram illustrating an example of how display elements are arrayed on a display surface of a display device.

FIG. 4 is a diagram illustrating an example of a transparent portion of a lattice unit.

FIG. 5 is a diagram illustrating an example of how the transparent portion of the lattice unit is superposed on black matrices of the display surface of the display device.

FIG. 6 is a diagram illustrating an example of a section of an optical unit.

FIG. 7 is a diagram depicting an example of arranging lens portions (lens elements) and grooves (lens grooves) of the optical unit in directions oblique to the array directions of the pixels on the display device.

FIG. 8 is a diagram illustrating an example of function blocks of the stereoscopic image generating device.

FIG. 9 is a diagram illustrating an example of a hardware configuration of the information processing device.

FIG. 10 is a flowchart illustrating an example of an operation flow of the stereoscopic image generating device.

FIG. 11 is a view depicting an example of how the lens sheet is attached to the display device.

FIG. 12 illustrates an example of displaying a purport saying that the stereoscopic image cannot be displayed on the display device.

FIG. 13 is a diagram illustrating an example of an organic EL (Electro Luminescence) sheet.

### DESCRIPTION OF EMBODIMENTS

An embodiment will hereinafter be described with reference to the drawings. A configuration of the embodiment is an exemplification, and the configuration of the disclosure is not limited to the specific configuration of the embodiment of the disclosure. Implementation of the configuration of the disclosure may involve properly adopting a specific configuration corresponding to the embodiment.

Herein, the stereoscopic image displayed by the stereoscopic image generating device may also be a dynamic image (moving picture) and a static image as well.

### Embodiment

(Example of Configuration)

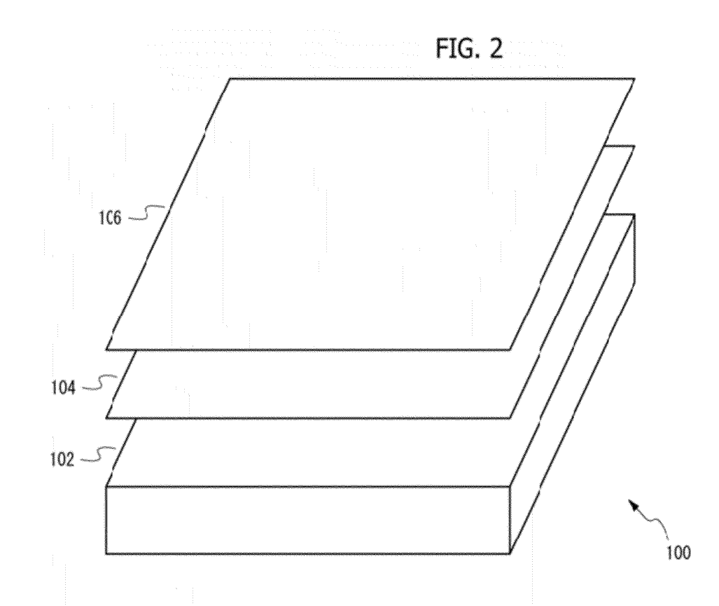

FIG. 2 is a view illustrating an example of a configuration of the stereoscopic image generating device of the embodiment. A stereoscopic image generating device 100 includes a display device 102, a lattice unit 104 and an optical unit 106. The stereoscopic image generating device 100 is configured by disposing, as in FIG. 2, the display device 102, the lattice unit 104 and the optical unit 106 in this sequence. The display device 102, the lattice unit 104 and the optical unit 106 are disposed substantially in parallel.

The display device 102 is, for example, a liquid crystal display. The display device 102 displays the image in response to an instruction inputted. The display device 102 displays the image on the surface on the side where the lattice unit 104 and the optical unit 106 are disposed.

Respective pixels on a display surface are formed by display elements on the display surface of the display device 102. The display elements are arrayed in a horizontal direction and in a direction orthogonal to the horizontal direction on the display surface. A screen of the display device 102 contains a plurality of pixels (PIXEL). Each of the pixels on the display device contains a plurality of color elements (color pixels). The color elements are exemplified such as red (R), green (G) and blue (B). Black matrices exist at borders between the respective pixels. The display device 102 displays the stereoscopic image. The stereoscopic image contains the image for the left eye and the image for the right eye.

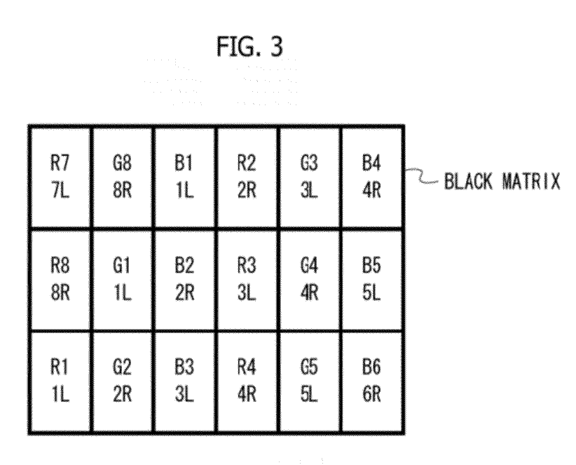

FIG. 3 is a diagram illustrating an example of an array of the display elements on the display surface of the display device. In the example of FIG. 3, for instance, a pixel 1L contains the respective color elements R1 (Red), G1 (Green) and B1 (Blue). This is the same with the pixels 2R, 3L, etc. The black matrices taking a lattice structure exist in the peripheries of the color elements. The black matrix is a non-brightness-emitting portion. In the example of FIG. 3, the color elements of one pixel are arranged in non-parallel with the pixel array directions (both of the horizontal direction and the direction orthogonal to the horizontal direction). The color elements of one pixel may also be arranged in parallel with the pixel array directions (both of the horizontal direction and the direction orthogonal to the horizontal direction).

The lattice unit 104 includes a lattice-shaped transparent portion which covers the black matrices on the display surface of the display device 102. The lattice unit 104 includes a light source. The light source is provided in the periphery of, e.g., the transparent portion. When supplied with the light from the light source, the transparent portion of the lattice unit 104 emits brightness (caused by radiation of the light). The light source is exemplified such as a cathode ray tube (CRT) and an LED (Light Emitting Diode). The light source may also be supplied with the electric power from the display device 102. The transparent portion of the lattice unit 104 has a size that is larger than or the same as the whole black matrices on the display surface of the display device 102. The display device 102 displays a normal two-dimensional image, in which case the electric power is not supplied to the light source of the lattice unit 104, with the result that the transparent portion of the lattice unit 104 does not emit the brightness. With no emission of brightness from the lattice unit 104, it is feasible to restrain a decline of quality of the displayed image in such a case that the display device 102 displays the normal 2D image. The transparent portion can involve using a transparent material such as an acrylic resin and glass through which the light penetrates. The normal 2D image is an image excluding the stereoscopic image.

The light emitted from the light source (the CRT, the LED, etc) installed, e.g., in the periphery of the transparent portion enters the transparent portion serving as a light-guiding panel, whereby the lattice unit 104 emits the brightness. To be specific, the light incident on the transparent portion from the periphery of the transparent portion diffuses over within the whole transparent portion serving as the light-guiding panel while the light repeatedly reflects on the surface of the transparent portion. Further, the light within the transparent portion is diffused by reflection dots or a reflection sheet of the surface of the transparent portion and is then radiated outside. The reflection dots or the reflection sheet are or is provided on the surface on the side of the display device 102. The transparent portion of the lattice unit 104 emits the brightness caused by the light being radiated outside. The transparent portion serving as the light-guiding panel can be made to emit the brightness uniformly throughout the transparent portion itself by reducing, e.g., areas of the reflection dots close to the light source while increasing the areas of the reflection dots distant from the light source. The lattice unit 104 may be provided with a plurality of light sources. The lattice unit 104 can emit the brightness owing to the same mechanism as a backlight of a liquid crystal display. The lattice unit 104 includes the light source and the transparent portion, i.e., when supplied with the electric power, the light source emits the light, and the transparent portion emits the brightness.

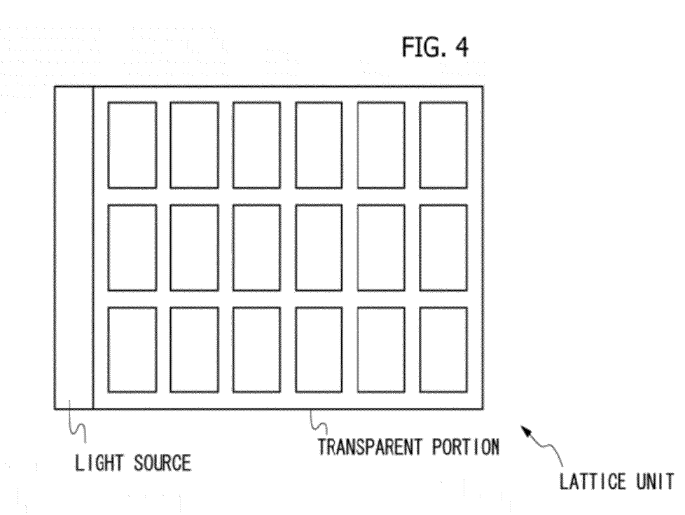

FIG. 4 is a diagram illustrating an example of the transparent portion of the lattice unit. The transparent portion of the lattice unit 104 takes the lattice shape. The transparent portion emits the brightness by its being supplied with the light from the light source. A lattice pitch of the transparent portion of the lattice unit 104 is equal to a pitch between the color elements. The light source is provided in the periphery of the transparent portion.

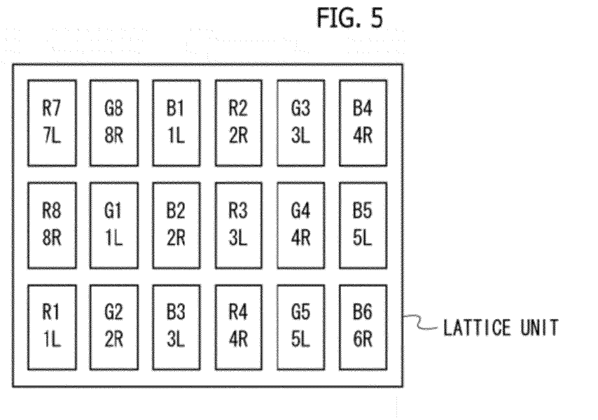

FIG. 5 is a diagram depicting an example of how the transparent portion of the lattice unit is superposed on the black matrices of the display surface of the display device 102. The lattice unit 104 is installed so that the black matrices of the display surface of the display device 102 in FIG. 3 are covered with the transparent portion of the lattice unit 104. Further, the color elements on the display surface of the display device 102 are visually recognized through the lattice of the transparent portion of the lattice unit 104. FIG. 5 omits the illustration of the light source of the lattice unit 104.

The optical unit 106 includes a plurality of lens portions (lens elements) which configure a lenticular lens (lenticular lens sheet) and grooves (lens grooves) between these lens portions. Each of the lens portions and each of the lens grooves take rectilinear shapes. The lens portions and the lens grooves are arranged in directions parallel with each other. One surface of the optical unit 106 is a flat surface. Another surface of the optical unit 106 on the side of the display device 102 may be contiguous to the lattice unit 104. The optical unit 106 forms the images coming from the display device in predetermined positions. The optical unit 106 forms the image for the left eye in the position corresponding to the left eye of the user and the image for the right eye in the position corresponding to the right eye of the user, which come from the display device. The lens portions and the lens grooves may be arranged in the directions parallel or non-parallel with the array directions of the display elements of the display surface of the display device. Further, the surface containing the lens portions of the optical unit 106 may be disposed on the side of the display device 102.

The entire surface of the optical unit 106 may be protected by a transparent flat panel. Each of the lenses used for the optical unit 106 is a curved lens (plano-convex lens) taking, e.g., a Quonset shape. The lenses used for the optical unit 106 correspond to the convex portions in the optical unit 106. The shape of the lens is not limited to the curved lens taking the Quonset shape. The shape of the curved lens taking the Quonset shape is a three-dimensional shape formed when scanning, in a direction of normal line of the plane, one of portions surrounded by a closed curve and a straight line in the case of cutting off, e.g., the closed curve (e.g., an ellipse) on the plane with the straight line on the plane. The shape of the curved lens taking the Quonset shape may also be a three-dimensional shape on one side, which is formed when cutting off, e.g., a cylinder (or an elliptic cylinder) with the plane parallel with a straight line in a heightwise direction of the cylinder (or the elliptic cylinder).

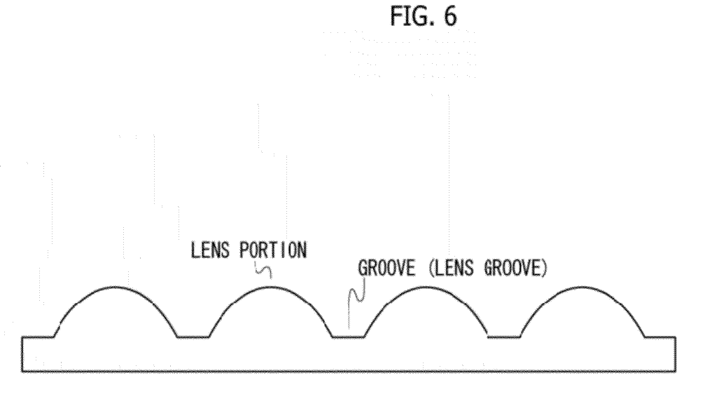

FIG. 6 is a diagram illustrating an example of a section of the optical unit. The optical unit 106 includes the plurality of lens portions (lens elements) and the lens grooves each existing between the lens portion and the lens portion. The lens portions take the shape of the lenticular lens on the whole. The lens groove has, e.g., a flat surface. Each of lens portions of the lenticular lens is the curved lens taking the Quonset shape.

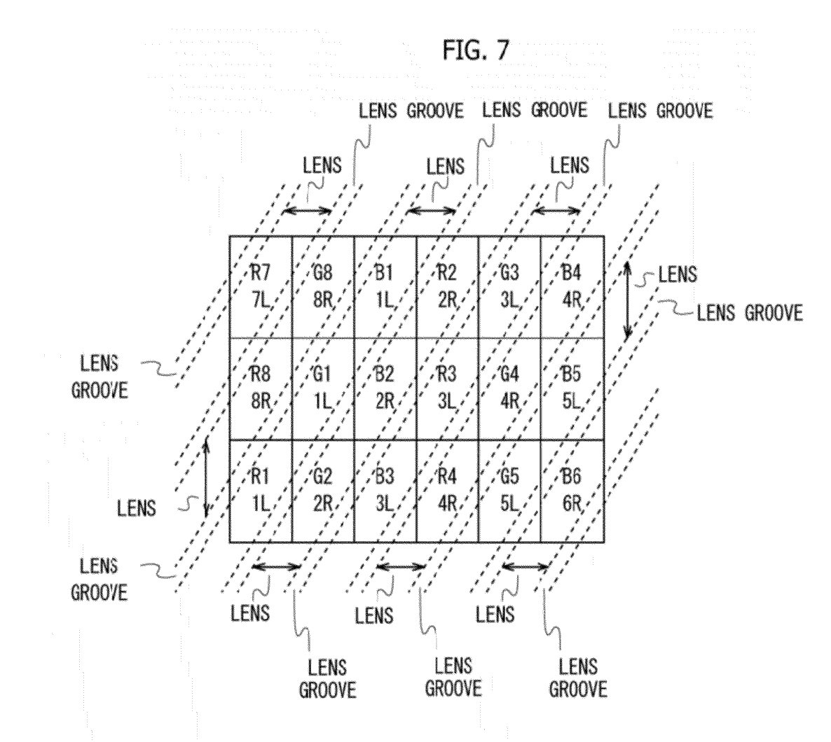

FIG. 7 is a diagram depicting an example of arranging the lens portions (lens elements) and grooves (lens grooves) of the optical unit in directions oblique to the array directions of the pixels on the display device. The elements (display elements) of the color elements are arrayed in the horizontal direction (crosswise direction in FIG. 7) with respect to the display surface and in the direction (vertical direction in FIG. 7) orthogonal to the horizontal direction. In the example of FIG. 7, the lens portions and the grooves are arranged in the direction (non-parallel direction) oblique to the vertical direction of the array of the image elements on the display device. The lens portions are arranged in the direction parallel with the direction in which the grooves are arranged. Along with this arrangement, the respective pixels displayed on the display device 102 are arrayed so that the respective sets of color elements are arranged in the oblique directions. For example, one set of color elements R1, G1, B1 form one pixel. Similarly, this formation is the same with other sets of color elements. The color elements of each pixel are arranged in the direction parallel with the direction in which each lens portion is arranged. In the example of FIG. 7, one pixel is arranged in the oblique direction. For instance, almost all the light emerging from the pixel “1L” is incident on the same lens element, and an image of this light is formed through the lens element in the position of the left eye of the user. Further, almost all the light emerging from the pixel “2R” is incident on the same lens element, and an image of this light is formed through the lens element in the position of the right eye of the user. This image formation is the same with other pixels. The pixels (1L, 3L, etc) of the images for the left eye and the pixels (2R, 4R, etc) of the images for the right eye, are alternately arranged.

In the example of FIG. 7, the pixels in the crosswise direction are reduced down to three-fourths as small as those of the 2D image. On the other hand, in the example of FIG. 7, the pixels in the vertical direction are reduced down to one-third as small as those of the 2D image. In the case of arranging the color elements R, G, B of one pixel in the crosswise direction, the pixels in the crosswise direction are reduced down to one-fourth as small as those of the 2D image. At this time, the pixels in the vertical direction do not decrease. As in FIG. 7, the lens element is arranged in the oblique direction, and one pixel is arranged in the oblique direction, whereby a resolution can be prevented from decreasing only in the crosswise direction. The decline of the image quality appears to be less when the resolution decreases in the vertical direction and the crosswise direction than decreasing only in the crosswise direction.

Moire fringes might occur due to interference between the black matrices visible to the eyes of the user via the lens grooves of the optical unit 106 and the black matrices visible to the eyes of the user via the lens portions of the optical unit 106.

The lattice unit 104 and the optical unit 106 may be integrated and may also be separated as well. The display surface of the display device 102 and the lattice unit 104 may be integrated and may also be separated as well.

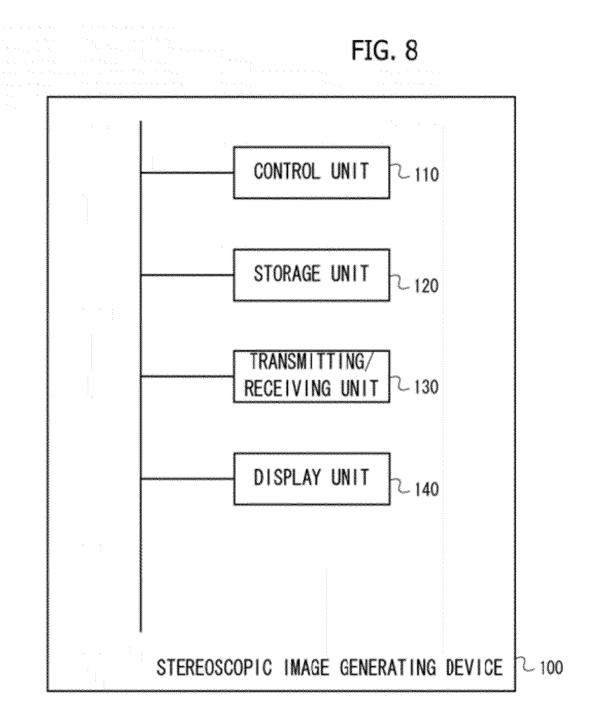

FIG. 8 is a diagram illustrating an example of function blocks of the stereoscopic image generating device. A stereoscopic image generating device 100 includes a control unit 110, a storage unit 120, a transmitting/receiving unit 130 and a display unit 140. The display unit 140, the control unit 110, the storage unit 120 and the transmitting/receiving unit 130 are connected via a bus.

The control unit 110 executes a program etc stored on the storage unit 120 and instructs the display device 102 to display a predetermined image. The control unit 110 can control the lattice unit 104. The control unit 110 controls the power supply to the transparent portion of the lattice unit 104. The control unit 110, e.g., when not the stereoscopic (3D) image but the 2D image is displayed on the display device 102, cuts off the power supply to the transparent portion of the lattice unit 104. The control unit 110 can operate as a cut-off unit.

The storage unit 120 gets stored with the program executed by the control unit 110 and various types of data utilized for the program. The storage unit 120 gets stored with the data of the stereoscopic image (e.g., the image data for the left eye and the image data for the right eye) displayed on the display device 102. The storage unit 120 may also be stored with information on various types of lens sheets.

The transmitting/receiving unit 130 performs communications with an external device via a network etc in accordance with an instruction given from the control unit 110. The transmitting/receiving unit 130 can receive a signal detected by a switch etc.

The display unit 140 displays the predetermined image on the display device 102 according to the instruction given from the control unit 110.

The stereoscopic image generating device 100 can be realized by employing a general-purpose computer such as a personal computer (PC: Personal Computer), a dedicated or general-purpose computer such as a workstation (WS: Work Station) and a PDA (Personal Digital Assistant), or an electronic apparatus mounted with the computer. Further, the stereoscopic image generating device 100 can be realized by use of the dedicated or general-purpose computer such as a smartphone, a mobile phone and a car navigations system, or the electronic apparatus mounted with the computer. The computer is referred to also as an information processing device.

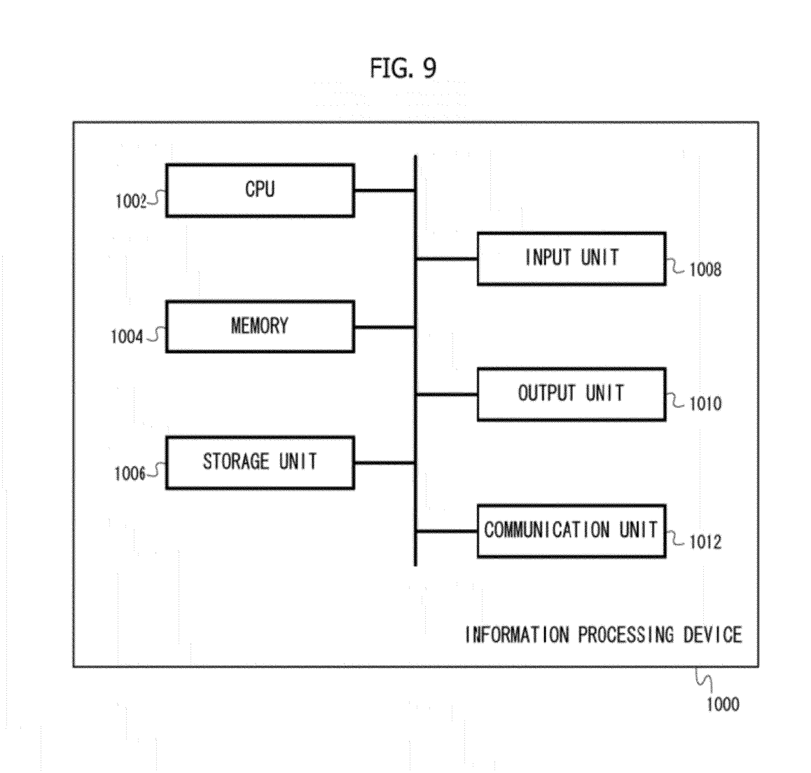

FIG. 9 is a diagram illustrating an example of a hardware configuration of the information processing device. The stereoscopic image generating device 100 is each realized by an information processing device 1000 as depicted in, e.g., FIG. 9.

The information processing device 1000 includes a CPU (Central Processing Unit) 1002, a memory 1004, a storage unit 1006, an input unit 1008, an output unit 1010 and a communication unit 1012.

In the information processing device 1000, the CPU 1002 loads the program stored in the recording unit 1006 into an operation area of the memory 1004 and executes the program, and peripheral devices are thus controlled through executing the program, thereby enabling actualization of the function which meets a predetermined purpose.

The CPU 1002 executes processes according to the program stored in the storage unit 1006.

The memory 1004 is a memory in which the CPU 1002 caches the program and the data and deploys the operation area. The memory 1004 includes, e.g., a RAM (Random Access Memory) and a ROM (Read Only Memory). The memory 1004 is a main storage device.

The storage unit 1006 stores the various categories of programs and the various types of data in the recording medium in a readable/writable manner. The storage unit 1006 is exemplified such as an EPROM (Erasable Programmable ROM), a solid-state drive (SSD: Solid State Drive) and a hard disk drive (HDD: Hard Disk Drive). The storage unit 1006 is further exemplified such as a CD (Compact Disc) drive, a DVD (Digital Versatile Disk) drive, a +R/+RW drive, a HD DVD (High-Definition Digital Versatile Disk) drive, or a BD (Blu-ray Disk) drive. Further, the recording medium is exemplified such as a silicon disk including a nonvolatile semiconductor memory (flash memory), the hard disk, the CD, the DVD, the +R/+RW, the HD DVD or the BD. The CD is exemplified by a CD-R (Recordable), a CD-RW (Rewritable) and a CD-ROM. The DVD is exemplified by a DVD-R and a DVD-RAM (Random Access Memory). The BD is exemplified by a BD-R, a BD-RE (Rewritable) and a BD-ROM. Moreover, the storage unit 1006 can include a removable medium, i.e., a portable recording medium. The removable medium is exemplified by a USB (Universal Serial Bus) memory or by a disk recording medium such as the CD and the DVD. The storage unit 1006 is a secondary storage device.

The memory 1004 and the storage unit 1006 are computer-readable recording mediums.

The input unit 1008 accepts an operation instruction etc given from a user etc. The input unit 1008 is an input device such as a keyboard, a pointing device, a wireless remote controller, a microphone, a digital still camera and a digital video camera. The CPU 1002 is notified of the information inputted from the input unit 1008.

The output unit 1010 outputs the data processed by the CPU 1002 and the data stored in the memory 1004. The output unit 1010 is an output device such as a CRT (Cathode Ray Tube) display, an LCD (Liquid Crystal Display), a PDP (Plasma Display Panel), an EL (Electroluminescence) panel, a printer, a speaker, etc.

The communication unit 1012 transmits and receives the data to and from the external device. The communication unit 1012 is connected to the external devices via, e.g., a signal line. The external devices are, e.g., another information processing device, another storage device, etc. The communication unit 1012 is, e.g., a LAN (Local Area Network) interface board or a wireless communication circuit for wireless communications.

The information processing device 1000 stores, in the storage unit 1006, an operating system (OS), the various categories of programs, a variety of tables, etc.

The OS is software (kernel) acting as an intermediary between the software (application software) and the hardware (hardware components), performing memory space management, file management and process-and-task management. The OS embraces a communication interface. The communication interface is defined as a program for transferring and receiving the data to and from another external device etc connected via the communication unit 1012.

The computer realizing the stereoscopic image generating device 100 is, with a processor loading the program stored in a secondary storage device into the main storage device and thus executing the program, thereby enabled to actualize a function as the control unit 110. On the other hand, the storage unit 120 is provided in a storage area of the main storage device or the secondary storage device. The transmitting/receiving unit 130 can be realized as the CPU 1002 and the communication unit 1012. The display unit 140 can be realized as the output unit 1010.

A series of processes can be executed hardwarewise and softwarewise as well.

Steps of describing the program contain, as a matter of course, the processes implemented in time-series along the sequence described therein and the processes that are, though not necessarily processed in time-series, executed in parallel or individually.

(Operational Example)

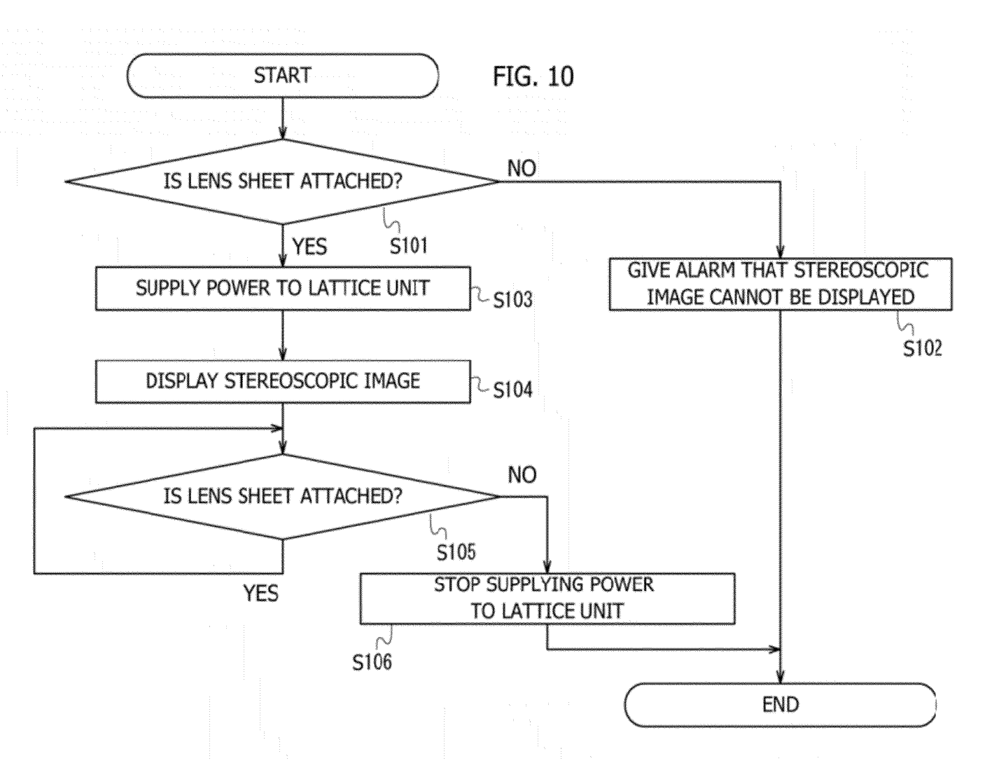

FIG. 10 is a flowchart illustrating an example of an operation flow of the stereoscopic image generating device. A start of the operation flow in FIG. 10 is triggered by starting up, e.g., a stereoscopic image reproducing program. The stereoscopic image reproducing program is stored in the storage unit 120. The stereoscopic image reproducing program is executed, thereby displaying the stereoscopic image on the display device 102.

The stereoscopic image generating device 100 checks whether or not the lattice unit 104 and the optical unit 106 are fitted to the display device 102 (S101). The optical unit 106 is referred to also as a lens sheet. The lens sheet may include the lattice unit 104. The stereoscopic image generating device 100 can check, by use of, e.g., a switch etc mounted on the display device 102, whether or not the lattice unit 104 and the optical unit 106 are attached to the display device 102. The switch is mounted at, e.g., a hook for fixing the lattice unit 104 and the optical unit 106 on the display device 102. The stereoscopic image generating device 100 detects an electrical signal of the switch mounted at the hook and is thereby enabled to recognize that the lattice unit 104 and the optical unit 106 are attached.

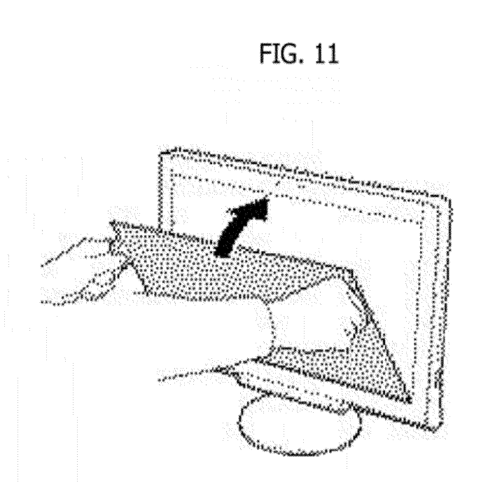

FIG. 11 is a view depicting an example of how the lens sheet is attached to the display device. The lens sheet is attached to the screen of the display device 102 in a way that fixes its position.

If the lens sheet is not attached to the display device 102 (S101; NO), the stereoscopic image generating device 100 displays a purport saying that the stereoscopic image cannot be displayed on the display device 102 (S102). The stereoscopic image generating device 100, even when the lens sheet is not normally attached, determines that the lens sheet is not attached. Thereafter, the stereoscopic image generating device 100 finishes the stereoscopic image reproducing program.

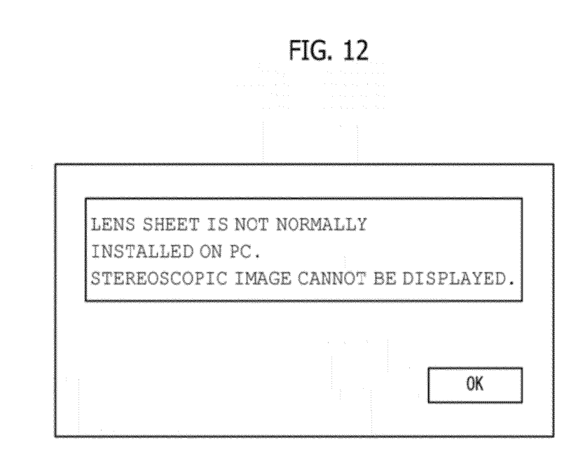

FIG. 12 illustrates an example of displaying a purport saying that the stereoscopic image cannot be displayed on the display device 102. The stereoscopic image generating device 100, when determining that the lens sheet is not attached, displays a purport (message) as in FIG. 12 on the display device 102.

When the lens sheet is attached to the display device 102 (S101; YES), the stereoscopic image generating device 100 supplies the electric power to the light source of the lattice unit 104, and the transparent portion of the lattice unit 104 emits the brightness (S103). The transparent portion of the lattice unit 104 emits the brightness, thereby making invisible the black matrices on the screen of the display device 102. The stereoscopic image generating device 100 can adjust the electric power supplied to the light source in a way that corresponds to, e.g., the brightness of screen on the display device 102.

The stereoscopic image generating device 100 displays the stereoscopic image on the display device 102 (S104). The stereoscopic image generating device 100 displays the image for the left eye in the pixels for the left eye and the image for the right eye in the pixels for the right eye.

The stereoscopic image generating device 100 checks whether the lens sheet is attached to the display device 102 or not (S105). If the lens sheet is attached to the display device 102 (S105; YES), the processing continues.

Whereas if the lens sheet is not attached to the display device 102 (S105; NO), the stereoscopic image generating device 100 stops supplying the electric power to the lattice unit 104 (S106). This is because if the lens sheet is not attached, the user is unable to visually recognize the stereoscopic image, and the moire fringes do not occur even when the lattice unit 104 is not caused to emit the brightness. Further, at this time, the user is unable to visually recognize the stereoscopic image, and hence the stereoscopic image generating device 100 may stop displaying the stereoscopic image while displaying one of the image for the left eye and the image for the right eye.

Moreover, the stereoscopic image generating device 100, when the image displayed on the display device 102 is (not the stereoscopic image but) the normal 2D image, can disable the lattice unit 104 from emitting the brightness by cutting off the power supply to the lattice unit 104.

(Effects of Embodiment)

The stereoscopic image generating device 100, which has the black matrices in the peripheries of the pixels on the display surface of the display device 102, includes the lattice unit 104 installed adjacent to the screen of the display device 102 and the optical unit which forms the image of the light coming from the display surface at the predetermined image forming point. The lattice unit 104 is installed so as to cover the black matrices as viewed from the user who visually recognizes the image on the display device 102. The lattice unit 104 emits the brightness, thereby disabling the user from visually recognizing the black matrices. The stereoscopic image generating device 100, owing to the emission of the brightness from the lattice unit 104, can restrain the occurrence of the moire fringes due to the black matrices.

The stereoscopic image generating device 100, with even the optical unit 106 including the lens portions that are non-parallel with the array directions of the display elements on the display surface of the display device 102, can restrain the occurrence of the moire fringes due to the black matrices.

Further, the stereoscopic image generating device 100, in the case of displaying the normal 2D image on the display device 102, can prevent the decline of the quality of the normal 2D image displayed on the display device by not causing the lattice unit 104 to emit the rightness while cutting off the power supply to the light source.

The configuration of the embodiment can be applied to a structure in which the interference fringes occur due to being affected by the black matrices without being limited to the interference fringes (moire fringes) between the black matrices and the optical unit 106 of the display device 102.

(Modified Example)

A quantity of brightness emitted (light emission quantity) from the lattice unit 104 can be varied corresponding to a light intensity of the whole screen. At this time, for instance, the quantity of brightness emitted from the lattice unit 104 is set to a quantity proportional to the luminosity of the screen (which is an integrated value of brilliance of the respective pixels). With this setting, it is feasible to restrain the occurrence of decline of the image quality due to the brightness emitted from the lattice unit 104 by decreasing the quantity of brightness emitted from the lattice unit 104 when the screen is dark.

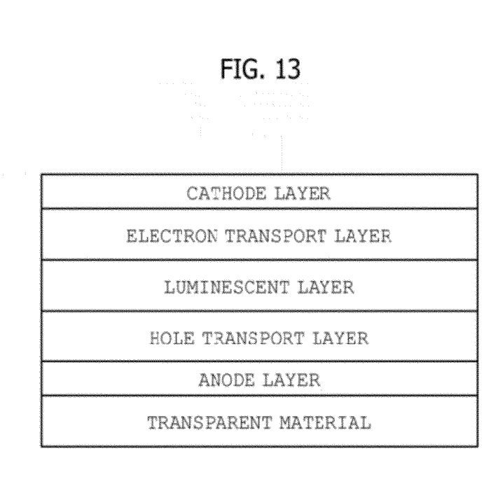

FIG. 13 is a diagram illustrating an example of an organic EL (Electro Luminescence) sheet. The organic EL sheet includes a cathode layer, an electron transport layer, a luminescent layer, a hole transport layer, an anode layer and a transparent material.

Described herein is an example of using the organic EL (Electro Luminescence) sheet for the lattice unit 104. The organic EL sheet, of which an organic substance is supplied with the electric power, gets luminous. The organic EL sheet is a self-luminous type of sheet, which is equal to or smaller than 1 mm in thickness but does not require the backlight, is defined as an element with no restriction in terms of a view angle. The organic EL sheet is configured such that an organic compound is sandwiched in between a pair of electrodes, and, when a DC voltage is applied, the hole is injected from the anode into the organic compound (luminescent layer), while the electron is injected from the cathode into the organic compound. When the hole is coupled with the electron within the organic compound, the organic compound comes to an excited state, thereby radiating the light. The luminescent layer defined also as the organic compound is exemplified such as what uses strontium monosulfide as a base agent and what is synthesized with zinc sulfide. The organic EL sheet is inserted under the transparent material and can be thereby uniformly reduced in weight. Hence, as in the configuration of FIG. 4, the organic EL sheet can be installed on the display device such as the liquid crystal display. It is generally possible to set luminance of the organic EL sheet at a level that is equal to or larger than 300 Cd/square meter. If this level of luminance is given, the brilliance emitted from the latticed organic EL sheet can cover the black matrices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A stereoscopic image generating device comprising:
a display device to include a plurality of pixels which emit brightness and non-brightness-emitting portions in the peripheries of the pixels;
a lattice unit to be installed in parallel with a display surface as well as being adjacent to the display surface of the display device and to include a brightness-emitting portion which covers the non-brightness-emitting portions; and
an optical unit to be installed in parallel with the lattice unit as well as being adjacent to the lattice unit and to include lens portions which form images of the light coming from the pixels at predetermined image-forming points.

2. The stereoscopic image generating device according to claim 1, wherein the lens portions of the optical unit are in non-parallel with array directions of display elements on the display surface of the display device.

3. The stereoscopic image generating device according to claim 1, further comprising a cut-off unit to cut off power supply to the brightness-emitting portions of the lattice unit when the display device displays a two-dimensional image.
